(19) United States
(12) Patent Application Publication
(10) Pub. No.: US 2008/0001906 A1
(43) Pub. Date: Jan. 3, 2008

(54) LCD device and scanning method thereof

(75) Inventor: Tsun-I Wang, Taoyuan Hsien (TW)

Correspondence Address: BIRCH STEWART KOLASCH & BIRCH, PO BOX 747, FALLS CHURCH, VA, 22040-0747, US

(73) Assignee: DYNASCAN TECHNOLOGY CORP.

(21) Appl. No.: 11/478,672

(22) Filed: Jul. 3, 2006

(51) Int. Cl. G09G 3/36

(52) U.S. Cl. 345/102

(57) ABSTRACT

An embodiment of the present invention is a LCD device that has no color filter, uses red, green, and blue LEDs as the sources of the backlight, and display a frame by presenting the frame's red, green, and blue sub-frames sequentially. The panel of the LCD device is partitioned into scanning areas and each scanning area is further partitioned into sections along the scan lines. The backlight module of the LCD device has a number of sets of LEDs, each corresponding to a section of the panel. Any two adjacent scanning areas are scanned line by line in opposite directions towards or away from their interfacing border. After a section is scanned and after the liquid crystal molecules have fully responded and reached their target grey levels, the corresponding LED set of the section is turned on.

### BACKGROUND OF THE INVENTION

1. Field of the Invention

The present invention generally relates to liquid crystal display (LCD) devices, and more particularly to a LCD device whose pixels are partitioned into scanning areas and adjacent scanning areas are scanned in opposite directions.

2. The Prior Arts

For a conventional colored LCD device, a sheet of color filter is attached to the front surface of the display panel so that colored images are presented by processing the white light from the backlight module's cold cathode fluorescent lamp (CCFL) tubes through the liquid crystal molecules of the display panel and the color filter. The color filter is the most expensive part among the components of a LCD device. Using a 14.1″ TFT-LCD device as an example, the color filter takes up about 28% of all material costs of the LCD device, which is much higher than the backlight module (18%) and other parts.

Along with the continuous advancement of light emitting diodes (LEDs), in addition to their production advantages in large-size LCD devices, LED-based, direct-lit backlight has become one of the mainstream technologies of LCD devices. If red-, green-, and blue-light LEDs are used as the light source of the direct-lit backlight module (they are usually arranged in an array), the costly color filter can be omitted. The color-filter-less LCD device has a number of advantages such as the higher brightness and better color gamut offered by the LEDs, and less energy loss by the omission of the color filter, in addition to significant cost reduction. However, these advantages come with a price.

A frame is presented by the color-filter-less LCD device using a direct-lit backlight module with red-, green-, and blue-light LEDs as follows. First, an original frame is separated into red, green, blue sub-frames. Then the presentation of the original frame is achieved by displaying the three sub-frames sequentially in an order. For example, the image data of the red sub-frame is first written into the pixels of the LCD device and the red-light LEDs of the backlight module is turned on. Subsequently, the image data of the green sub-frame is written into the pixels of the LCD device and the green-light LEDs of the backlight module is turned on. Then, the same process is applied to the blue sub-frame as well. Due to the human's visual persistence, a viewer only perceive the combined effect of the three sub-frames (i.e., the original frame), instead of separate presentations of the three sub-frames.

The present speed (i.e., frame rate) of the original frames is 60 Hz, meaning that the display time of each original frame (i.e., frame time) is 1/60 sec. In other words, the frame time for each sub-frame will only be 1/180 sec.≈5.55 ms. Within this period of time, the image data of an entire sub-frame has to be completely written into the pixels of the LCD device, and the corresponding colored LEDs of the backlight module have to be turned on. Using a LCD TV of a resolution 1920×1080 (i.e., total 1920×1080 pixels), the image data of a sub-frame is written into the pixels by enabling the 1920 pixels in a row, then the image data for these 1920 pixels are written into the row of pixels simultaneously, and then the process is repeated row by row for all 1080 rows. The data written into a pixel actually controls the grey level (i.e., transparency) of the pixel's liquid crystal molecule so as to present the colored light from the backlight module in various levels of brightness. Due to various factors such as the response time of the driving circuit, the parasitic capacitance along the wiring, the time required for completing the enabling and writing of image data to a row of pixels (hereinafter, the scanning time of a row of pixels) is about 10˜20 μs. For the 1920×1080 LCD device, the display of a sub-frame therefore requires about 10˜20 μs×1080=10˜20 ms, far exceeding the aforementioned 5.55 ms frame time for a sub-frame.

To overcome the problem of scanning time being too long in a large-size LCD device, a conventional approach is to partitioned the pixels of the LCD device into N (N>1) horizontal scanning areas, and then to conduct scanning to a row of pixels in each scanning area simultaneously. In other words, at any point of time, there are N rows of pixels (i.e., one from each scanning area) being scanned simultaneously. Assuming that the 1920×1080 LCD device is partitioned into four scanning areas, the scanning time for an entire sub-frame can be reduced to ¼ of the original 10˜20 ms, which is about 10˜20 ms/4=2.5˜5 ms, satisfying the requirement of 5.55 ms frame time. However, the problem is not satisfactorily resolved due to the retardation property of liquid crystal molecules. When data is written into a pixel, the pixel's liquid crystal molecule takes some time to reach the desired grey level and, only after that happens, the LEDs of the backlight module then can be turned on. Under the current progress of liquid crystal material and overdriving techniques, the response time of liquid crystal molecules is about 2˜3 ms and, adding the scanning time of 2.5˜5 ms, the total is very close to the 5.55 ms requirement, leaving almost no room for turning on the LEDs.

Therefore, U.S. Pat. No. 6,448,951 provides a solution in which, as illustrated in FIG. 1a, the pixels are partitioned horizontally into three scanning areas S1, S2, and S3. Each scanning area again is partitioned horizontally into a number of sections (e.g., ten sections in this example). Accordingly, as illustrated, the scanning area S1 is portioned into sections I₁˜I₁₀, the scanning area S2 is partitioned into sections I₁₁˜I₂₀, and the scanning area S3 is partitioned into sections I₂₁˜I₃₀. Correspondingly, the LEDs of the backlight module are partitioned so that each section of pixels has a corresponding set of LEDs (hereinafter, LED sets) and therefore the backlight module contains totally 30 LED sets. Each LED set contains appropriate numbers of red-, green-, and blue-light LEDs arranged in an appropriate manner to light up the pixels in the corresponding section. To display a sub-frame, the rows of pixels in the section I₁ of the scanning area S1, the section I₁₁ of the scanning area S2, and the section I₂₁ of the scanning area S3, respectively, are scanned row by row simultaneously. After the three sections I₁, I₁₁, and I₂₁ are completed, the rows of pixels in the section I₂ of the scanning area S1, the section I₁₂ of the scanning area S2, and the section I₂₂ of the scanning area S3, respectively, are then scanned row by row simultaneously. The process is repeated until all sections are scanned. When the scanning of a section is completed, the corresponding LED set behind the section is lighted up while, in the mean time, other sections are being scanned. In other words, the scanning and the lighting up of sections are conducted concurrently. Assuming that a display device has 1080 rows of pixels, each section I₁, I₂, . . . , or I₃₀ has 36 rows of pixels. If the scanning time for each row of pixels is 15 μs, it would take 15 μs×36=0.54 ms to complete the scanning of a section. Considering the 3-ms response time for the liquid crystal molecules to reach their target grey levels, there is still about 2 ms (5.55 ms-0.54 ms-3 ms) for lighting up the corresponding LED set. Therefore, U.S. Pat. No. 6,448,951 indeed effectively resolves the problems of not enough scanning time and the retardation property of liquid crystal molecules.

However, U.S. Pat. No. 6,448,951 suffers an additional problem in displaying dynamic images where there is visual discontinuity at the borders of adjacent scanning areas. When the content of the images changes faster, the visual discontinuity would be even more severe. As shown in FIG. 1b, the image of a frame P1 has three parts P1-1, P1-2, P1-3 each is presented by the scanning areas S1, S2, and S3 respectively as they are scanned in the directions shown by the arrow heads. Assuming that the frame image P1 has two objects located at the pixel A on the last row of P1-1 and the pixel C on the last row of P1-2. In the next frame P2 having three parts P2-1, P2-2, and P2-3, the two objects moves to the pixel B on the first row of P2-2 and the pixel D of the first row of P2-3, respectively. When P1-1, P1-2, and P1-3 are scanned completely and simultaneously (i.e., the last sub-frame, say blue sub-frame, is completely scanned), the scanning of first sub-frame of the next frame P2's P2-1, P2-2, and P2-3 is started. As the scanning is not continuous and the color is different, the two objects appear to jump to the pixels B and D. Additionally, U.S. Pat. No. 6,448,951 requires that the number of sections has to be a multiple integral of three and has to be equal or larger than six, making the approach less flexible in terms of their application.

### SUMMARY OF THE INVENTION

Therefore, the motivation of the present invention is to achieve the resolution of the problems of conventional, color-filter-less LCD devices. However, the LCD device proposed by the present invention can be one with or without color filter. The major characteristics of the LCD device lies in that: (1) the scan lines of the LCD device are partitioned horizontally or vertically along the scan lines into two or more scanning areas; and (2) the scan lines of any two adjacent scanning areas are scanned line by line towards or away from each other.

An embodiment of the present invention is a LCD device that has no color filter, uses red, green, and blue LEDs as the sources of the backlight, and displays a frame by presenting the frame's red, green, and blue sub-frames sequentially. Due to the aforementioned characteristics, the present invention does not suffer the discontinuity problem of dynamic images and, on the other hand, provides a more flexible partition of scanning areas.

The proposed LCD device contains a panel, a backlight module, and a driving mechanism. The panel contains P (P≧2) scan lines, each having Q (Q≧2) pixels. The P scan lines are partitioned into non-overlapping N (N≧2) scanning areas along the scan lines. Depending on the direction of the scan lines, the N scanning areas can be partitioned vertically or horizontally relative to the panel. The driving mechanism has P/N gate lines, each connecting to a scan line in each of the N scanning areas. The driving mechanism also has NxQ data lines partitioned into N groups, each having Q data lines. The Q data lines in one of the N groups are for writing data into the Q pixels of the scan lines in a scanning area. The gate lines and the scan lines are connected in a particular manner so that, when the driving mechanism enables the gate lines in a specific order to display a sub-frame, the scan lines in any two adjacent scanning areas are scanned line by line towards or away from the interfacing border of scanning areas.

Each scanning area is further partitioned into non-overlapping M (M≧1) sections along the scan lines. The backlight module of the LCD device has N×M LED sets, each having an appropriate number of appropriately arranged red, green, and blue LEDs. Behind each section of the panel, there is a corresponding LED set in the backlight module. After a section is scanned and after the liquid crystal molecules have responded and fully reached their target grey levels, the corresponding LED set of the section is turned on until the driving mechanism begins to write image data of the next frame into the section.

With the foregoing design, the discontinuity problem of dynamic images can be avoided. Additionally, by prematurely turning off the LED set behind a section before the image data is written into the section, the light leakage problem of the backlight module can also be resolved effectively.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIGS. 1a and 1b are schematic diagrams showing the partition of scanning areas of a conventional LCD device.

FIGS. 2a and 2b are schematic diagrams showing the scanning sequence according to a first embodiment of the present invention.

FIGS. 3a and 3b are schematic diagrams showing the interconnection between the gate lines and the scan lines of FIGS. 2a and 2b.

FIG. 4 is a timing diagram according to the first embodiment of the present invention.

FIG. 5 is another timing diagram according to the first embodiment of the present invention.

FIG. 6 is a schematic diagram showing the brightness distribution across the sections of scan lines according to the present invention.

FIGS. 7a, 7b, and 7c are schematic diagrams showing the scanning sequence according to a second embodiment of the present invention.

FIGS. 8a, 8b, and 8c are schematic diagrams showing the scanning sequence according to a second embodiment of the present invention.

FIG. 9 is a table summarizing the features of various embodiments of the present invention.

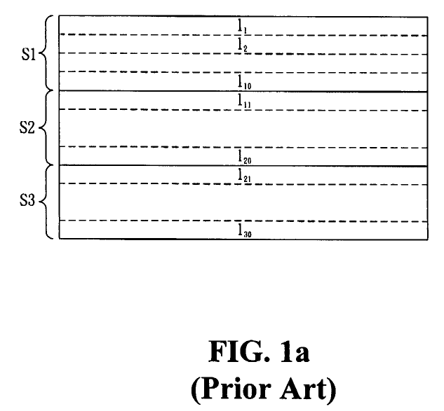

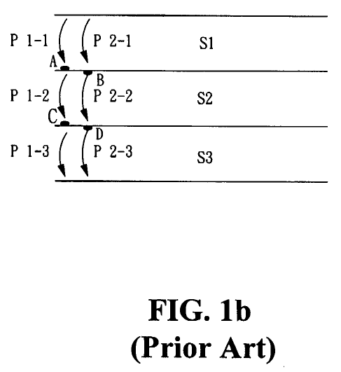

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

As mentioned earlier, the present invention arises from the resolution of the discontinuity problem of conventional color-filter-less LCD devices. However, the LCD devices proposed by the present invention can be ones with or without color filters. The related scanning methods are also applicable to LCD devices with or without color filters. In the following, a number of more complicated embodiments of the LCD device of present invention will be described first. These LCD devices all have no color filter, use red, green, and blue LEDs as backlight sources, and separate a frame into red, green, and blue sub-frames which are displayed sequentially. Once these more complicated embodiments are understood, the application of the present invention to LCD devices with color filters requires no further explanation. In other words, the present invention does not specifically require the presence or the omission of the color filter, but the present invention is most valuable when there is no color filter.

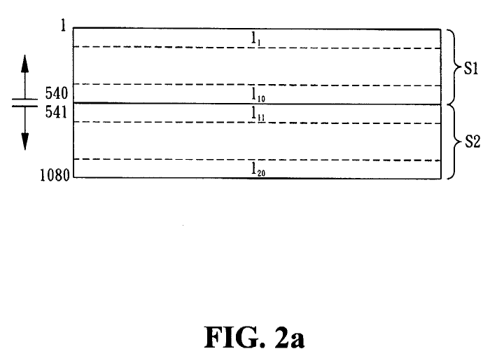

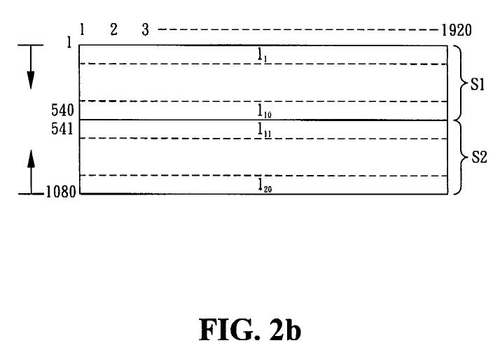

FIGS. 2a and 2b are schematic diagrams showing the scanning sequence according to a first embodiment of the present invention. In this embodiment, it is assumed that the LCD device has a resolution 1920×1080, but the present invention can actually applied to LCD devices of other resolutions. As illustrated, the pixels of the LCD device is partitioned horizontally into scanning areas S1 and S2, each containing 540 rows of pixels numbered as row 1˜540, and row 541˜1080, respectively (hereinafter, each row of pixels is referred to as a scan line). Each scanning area is further partitioned into 10 sections numbered as I₁˜I₁₀ and I₁₁˜I₂₀, each containing 54 scan lines. Behind each section, the backlight module of the LCD device (not shown) has a correspond LED set so as to illuminate the scan lines within each section. In other words, the LED set behind the section I₁ illuminates the scan lines 1˜54, the LED set behind the section I₂ illuminates the scan lines 55˜108, and so on. Each LED set contains an appropriate number of appropriately arranged red, green, and blue LEDs. The backlight module has an appropriate driving circuit under the control of a driving mechanism to individually control the on/off of the various colored LEDs within each set. The number and arrangement of the LEDs and the driving circuit should be quite familiar to people of related arts and their details are omitted here.

To resolve the discontinuity problem of dynamic images, the scan lines of the scanning areas S1 and S2 are scanned line by line towards or away from their interfacing border. As shown in FIG. 2a, the scanning area S1 is scanned from the scan line 540, 539, . . . , down to the scan line 1, while the scanning area S2 is scanned concurrently from the scan line 541, 542, . . . , up to the scan line 1080. In contrast, in FIG. 2b, the scanning area S1 is scanned from the scan line 1, 2, . . . , up to the scan line 540, while the scanning area S2 is scanned concurrently from the scan line 1080, 1079, . . . , down to the scan line 541. In other words, in FIG. 2a, the scanning areas S1 and S2 are scanned in an opposite direction away from their interfacing border (i.e., from the scan lines 540 and 541 respectively). In FIG. 2b, the scanning areas S1 and S2 are scanned also in an opposite direction towards their interfacing border (i.e., to the scan lines 540 and 541 respectively). As such, the jump or discontinuity phenomenon across the border can be completely resolved.

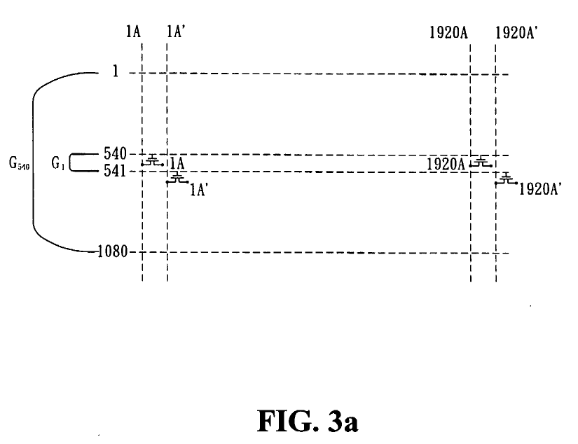

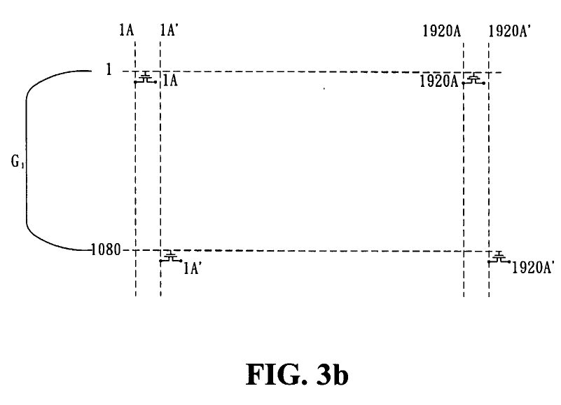

To achieve the scanning sequence shown in FIG. 2a, the implementation is explained as follows. As shown in FIG. 3a, to scan the scanning areas S1 and S2 in an opposite direction away from their border, the scan line 540 of the scanning area S1 and the scan line 541 of the scanning area S2 have to be scanned simultaneously. Therefore, as shown in FIG. 3a, the two scan lines are connected to a gate line G₁ from the same gate driver. The scenario applies to other scan lines as well until the scan line 1 of the scanning area S1 and the scan line 1080 of the scanning area S2 are connected to the same gate line G₅₄₀. Similarly, as shown in FIG. 3b, to achieve the scanning sequence shown in FIG. 2b, the scan line 1 of the scanning area S1 and the scan line 1080 of the scanning area S2 are connected to the same gate line G₁, and so on. In the present embodiment, therefore, the LCD device requires total 540 gate lines.

Using FIG. 3a as an example, when the gate line G₁ is enabled to scan both the scan lines 540 and 541 of the two scanning areas S1 and S2, image data has to be written into the 1920 pixels of the scan line 540 and the 1920 pixels of the scan line 541 simultaneously. For example, the image data for the first pixels of the scan lines 540 and 541 is written through two data lines 1A and 1A′ respectively, via a so-called source driver or data driver. Similarly, the image data for the 1920^{th} pixels of the scan lines 540 and 541 is written through two data lines 1920A and 1920A′ respectively. In the present embodiment, therefore, the LCD device requires total 1920×2=3840 data lines separated into two groups, each having 1920 data lines for the 1920 pixels of the scan lines of a scanning area. For a conventional 1920×1080 LCD device having color filter, up to 1080 gate lines are required. In addition, as red, green, and blue image data has to be delivered to the three sub-pixels of a pixel simultaneously, up to 1920×3=5760 data lines are required. In contrast, the present embodiment requires only 540 gate lines and, as the red, green, and blue image data is delivered in a time-division manner, only up to 3840 data lines are required.

In this specification, the so-called “horizontal” or “vertical” direction is referred relative to the panel of the LCD device. Please note that, in the foregoing embodiment, the scanning areas are partitioned horizontally because conventionally the scan lines are arranged horizontally and the data lines are arranged vertically. Technically, a panel can also have the scan lines arranged vertically and the data lines arranged horizontally. For this kind of panel, the scanning areas will be partitioned vertically. Therefore, more specifically, the partition of the scanning areas of the present invention is conducted parallel to the scan lines. In the following, for simplicity and without losing generality, the subsequent embodiments assume that the scan lines are arranged horizontally and therefore the scanning areas are partitioned horizontally.

Take the foregoing embodiment as an example, if the scan lines are arranged vertically and the data lines are arranged horizontally, then, up to 960 (1920/2) gate lines and 2160 (1080×2) data lines are required. In other words, for panels of vertically arranged scan lines, the total number of gate lines and data lines will be further reduced, contributing an even lower cost.

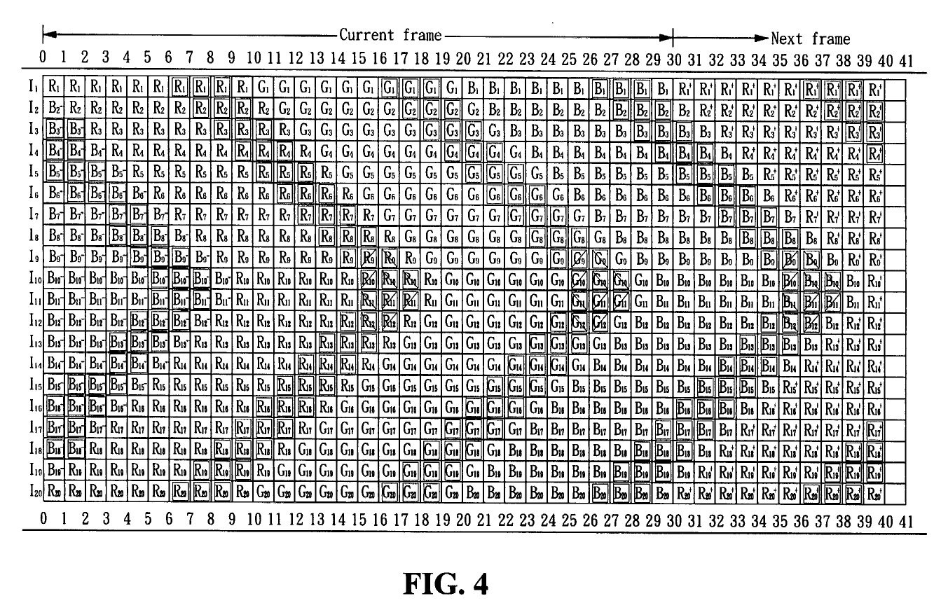

To further explain the principle of the present invention, FIG. 4 provides a timing diagram based on the scanning sequence of FIG. 2b. As shown in FIG. 4, each vertical column shows the data and status of the sections I₁˜I₂₀ at a particular point of time (i.e., the horizontal axis). For a section, it is denoted as Rₙ, Gₙ, or Bₙ when the section contains the image data of the red, green, or blue sub-frame of a current frame (n), respectively. When the LED set behind the section is turned on, the section is denoted as an Rₙ, Gₙ, or Bₙ encircled by a box. On the other hand, Rₙ⁻, Gₙ⁻, or Bₙ⁻ refers to the image data of the red, green, or blue sub-frame of a previous frame (n⁻); and Rₙ⁺, Gₙ⁺ or Bₙ⁺ refers to the image data of the red, green, or blue sub-frame of a next frame (n⁺). In the present embodiment, time is measured by a unit ΔT which is the period of time required to scan an entire section. Therefore, a point of time Tₙ is equal to nΔT and all periods of time are multiple integrals of ΔT. As the period of time required to finish the simultaneous scanning of the scanning areas S1 and S2 cannot exceed the 5.55-ms sub-frame time, the scanning time of each scan line (including the time for enabling the gate line, writing data via the data lines, and storing the data by the pixels) is at most 5.55 ms/540≈10.3 μs. Since each section contains 54 scan lines, the scanning time of a section ΔT is 10.3 μs×54≈0.55 ms. Please note that to reduce the scanning time of a scan line down to 10.3 μs is not practical with existing technologies. However, the present embodiment is described here mainly as a simplified example to the principle and operation of the present invention.

The present embodiment displays the red, green, and blue sub-frames sequentially. Therefore, after the initial 10ΔT (i.e., at T₁₀), the image data R₁˜R₂₀ of the red sub-frame has been written into the sections I₁˜I₂₀. Then, after another 10ΔT (i.e., at T₂₀), the image data G₁˜G₂₀ of the green sub-frame has been written into the sections I₁˜I₂₀. Again, after another 10ΔT (i.e., at T₃₀), the image data B₁˜B₂₀ of the blue sub-frame has been written into the sections I₁˜I₂₀. Accordingly, to display an original frame (i.e., to display its red, green, and blue sub-frames), total 30ΔT (i.e., T₀˜T₃₀) is required which is about 0.55 ms×30≈16.6 ms and is marked as the “current frame” in FIG. 4. After T₃₀, it is the frame time of the next frame. Take the sections I₁ and I₂₀ as example, they are scanned and the image data R₁ and R₂₀ are written during T₀˜T₁. Then, the red LEDs in the corresponding LED sets cannot be turned on until the liquid crystal molecules complete the response time and reach the target grey levels. If As the response time of liquid crystal molecules is about 3 ms, it has to wait 6ΔT (0.55 ms×6=3.3 ms) and then turns on the red LEDs in the LED sets behind the sections I₁ and I₂₀ at T₆. The red LEDs remain on until T₉, when the image data G₁ and G₂₀ of the green sub-frame begins to be written into the sections I₁ and I₂₀. In other words, during the 5.55 ms where a section displays a sub-frame, the backlight LEDs corresponding to the section and the sub-frame is turned on for 1.65 ms (T₇˜T₁₀), which is long enough to accurately present the color and brightness of the image of the section. Please note that LEDs also have a response time but it is in the range of nano-seconds and therefore is ignored here. How the discontinuity problem is resolved by the present invention can also be seen from FIG. 4. During T₁₅˜T₁₈, the two sections I₁₀ and I₁₁ at the interface of the scanning areas S1 and S2 contains red image data R₁₀ and R₁₁, and the two sections' corresponding red LEDs are turned on as well. In other words, the image data of a same sub-frame is presented continuously across the interface of the scanning areas S1 and S2. Therefore, the discontinuity problem arising from the display of different color images of different sub-frames simultaneously across the interface of scanning areas is effectively resolved. Please note that, during T₇˜T₁₀, the image data R₁ and R₂₀ of sections I₁ and I₂₀ are illuminated while the image data B₈⁻˜B₁₃⁻ of the previous blue sub-frame in sections I₈˜I₁₃ are also illuminated. The illuminated data belongs two different frames and is in different colors. However, as there are 54×7=378 scan lines between I₁ and I₈ and between I₁₃ and I₂₀, the human eye wouldn't develop discontinuous feeling from such a distance. Accordingly, as can be seen from FIG. 4, the discontinuity problem of dynamic images can be effectively resolved by time-division scanning of sub-frames in opposite directions.

As also shown in FIG. 4, during T₁₀˜T₁₁, the red image data R₂ of the section I₂ is illuminated while the green image data G₁ is scanned into the section I₁. Ideally, the light from the LED set behind the section I₂ wouldn't leak to illuminate the section I₁. However, in reality, the light for illuminating a section would inevitably illuminate a number of scan lines in adjacent sections. This would cause incorrect image presentation (e.g., the grey levels of some pixels are determined by green image data while they are illuminated by red light). To resolve this light leakage problem, one way is to more precisely control the scanning time and when to turn on the LEDs by using a time unit of finer granularity.

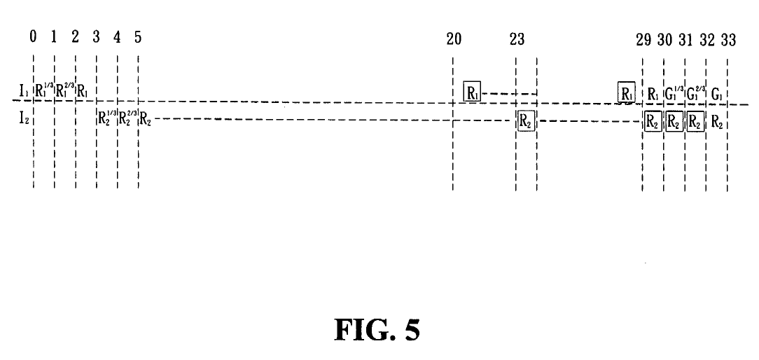

For example, if the time unit ΔT′ is reduced to ⅓ΔT so that ΔT′=0.183 ms, a frame time would take 90ΔT′, each sub-frame time would take 30ΔT′, and the scanning time of each section is 3ΔT′. Therefore, the timing diagram of FIG. 4 would be extended three folds and a portion of it is shown in FIG. 5. As illustrated, after the first ΔT′, only one third of the scan lines of a section are scanned and the section is denoted as Rₙ^{1/3}, Gₙ^{1/3} or Bₙ^{1/3}; after the second ΔT′, two third of the scan lines of the section are scanned and the section is denoted as Rₙ^{2/3}, Gₙ^{2/3}, or Bₙ^{2/3}; and after the third ΔT′, all scan lines of the section are scanned and the section is Rₙ, Gₙ, or Bₙ.

As illustrated, when T₁ is reached, Rₙ^{1/3} is scanned. Similarly, when T₂, T₃ are reached, Rₙ^{2/3} and Rₙ are scanned respectively. Since the liquid crystal molecules would need 3 ms response time to reach target grey levels, the red LEDs of the LED set behind the section I₁ are turned on after waiting 17ΔT′ (0.183 ms×17=3.1 ms) until T₂₀ for the liquid crystal molecules to completely respond. In the previous embodiment where ΔT=0.55 ms, the waiting time is 6ΔT (3.3 ms) and some unnecessary waiting time is wasted. In the present embodiment where ΔT′=0.183 ms, the waiting time is 17 ΔT′ (3.1 ms) and less time is wasted. The scenario applies to the other sections accordingly. For example, the section I₂ is scanned from T₃ after the section I₁ has completed scanning. Then, after T₆ where the section I₂ has completed scanning, another 17ΔT′ are required to wait for the liquid crystal molecules to respond until T₂₃ where the red LEDs of the LED set behind the section I₂ is turned on.

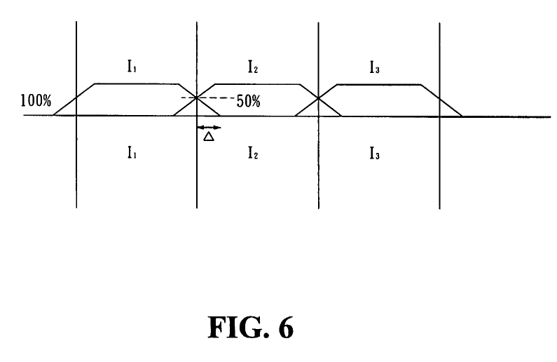

Following the previous embodiment, the red LEDs of the LED sets behind the sections I₁ and I₂ should remain on until T₃₀ and T₃₃ respectively, where the green image data G₁ and G₂ begin to be written. However, as shown in FIG. 6, the present embodiment turns off the red LEDs for the sections I₁ and I₂ prematurely at T₂₉ and T₃₂ respectively. During T₂₉˜T₃₀, the red LEDs for the section I₂ is also turned on while the red LEDs for the section I₁ is already turned off. During T₃₀˜T₃₁, the red LEDs for the section I₂ remains on while the green image data Gₙ^{1/3} is scanned into the section I₁. During T₃₁˜T₃₂, the red LEDs for the section I₂ remains on while the green image data Gₙ^{2/3} is scanned into the section I₁. As can be seen from FIG. 5, as long as the light leakage does not go beyond one third of the scan lines of the adjacent sections, the light leakage wouldn't produce incorrect image presentation. For example, during T₃₀˜T₃₂, the red light leaked from the section I₂ to the section I₁ wouldn't illuminate the green image data already scanned into the first two third of the scan lines of the section I₁. On the contrary, as the last one third of the scan lines of the section I₁ still contains red image data, the light leakage actually enhance the brightness of the image. Then, during T₃₂˜T₃₃, the green image data begins to be scanned into the last one third of the scan lines of the section I₁, the red LEDs for the section I₂ therefore have to turned off earlier.

FIG. 6 is a schematic diagram showing the brightness distribution across the sections of scan lines according to the present invention. As illustrated, the brightness of the backlight for the section I₁ drops linearly to 50% at the border interfacing an adjacent section and further drops to zero when it crosses the border for a distance Δ. As mentioned earlier, Δ should be as small as possible but it cannot be completely eliminated. However, when the backlight LEDs for two adjacent sections are both turned on such as during T₂₃˜T₃₀, the brightness at the border is compensated by the leakage from the adjacent section and therefore is still 100%.

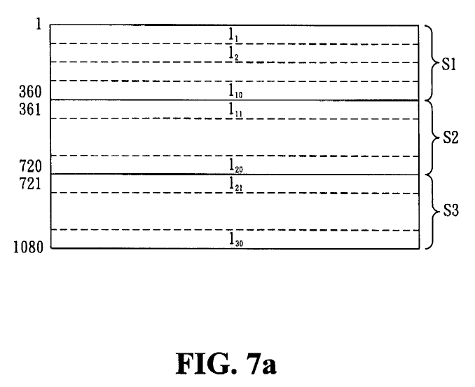

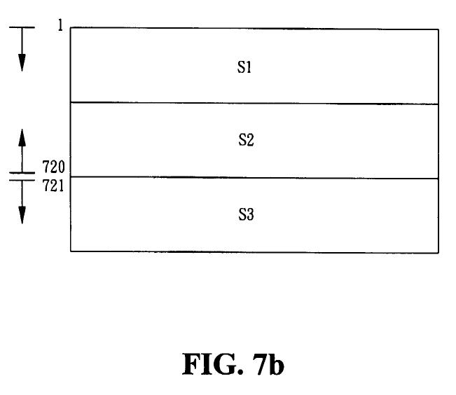

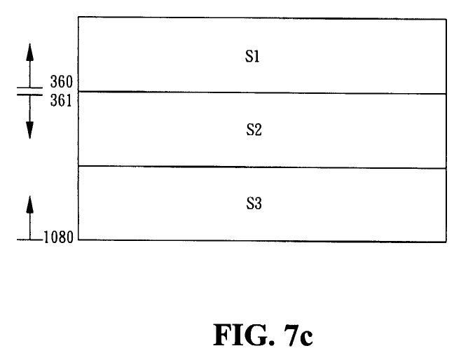

FIGS. 7a, 7b, and 7c are schematic diagrams showing the scanning sequence according to a second embodiment of the present invention. As shown in FIG. 7a, the panel is partitioned horizontally parallel to the scan lines into three scanning areas S1, S2, and S3, each having 360 scan lines. The scan lines of the scanning areas S1, S2, and S3 are referred to as the scan lines 1˜360, 361˜720, and 721˜1080, respectively. For each scanning area, its scan lines are further partitioned horizontally parallel to the scan lines into ten sections. The sections of the scanning areas S1, S2, and S3 are denoted as I₁˜I₁₀, I₁₁˜I₂₀, and I₂₁˜I₃₀, respectively. According to the present invention, the line-by-line scanning directions of any two adjacent scanning areas are either facing each other (i.e., towards their interfacing border) or opposite to each other (i.e., away from their interfacing border). Therefore, the present embodiment can have two scanning sequences as shown in FIGS. 7b and 7c respectively. In FIG. 7b, the scanning directions of the scanning areas S1 and S2 are face-to-face while the scanning directions of the scanning areas S2 and S3 are back-to-back. In FIG. 7c, the scanning directions of the scanning areas S1 and S2 are back-to-back while the scanning directions of the scanning areas S2 and S3 are face-to-face.

As there are three scanning areas in the present embodiment, no matter which scanning sequence of FIG. 7b or 7c is adopted, three scan lines have to be scanned simultaneously. Therefore, for example, the scan lines 1, 720, and 721 are connected to the same gate line and total 1080/3=360 gate lines are required. On the other hand, when three scan lines are scanned at the same time, the image data has to be written into the 1920 pixels of each of the three scan lines simultaneously. The present embodiment therefore requires 1920×3=5760 data lines. As the simultaneous scanning of the three scanning areas has to be finished within the 5.55-ms sub-frame time, the scanning time for each scan line is 5.55 ms/360≈15.4 μs. This speed is achievable by the existing technologies. Each section has 36 scan lines and the scanning time for each section is 15.4 μs×36=0.55 ms. With the 3-ms liquid crystal response time, there is about 2 ms left to turn on the LEDs.

The present embodiment has a ΔT=0.55 ms and each section needs 10ΔT to display a sub-frame. Within the 10ΔT, the first ΔT is for scanning image data into the section, six ΔTs (6×0.55 ms=3.3 ms) are for liquid crystal molecules to fully respond, and three ΔTs are for illuminating the section. In addition, when the scan lines near the border between adjacent scanning areas are scanned according to the present invention, they contain image data of a same sub-frame and therefore there is no discontinuity phenomenon. Similarly, if the time unit ΔT′ is reduced to ⅓ΔT (0.55 ms/3≈0.183 μs), each section needs 30ΔT′ to display a sub-frame. Within the 30ΔT′, the first three ΔT's are for scanning image data into the section, 17ΔT's (17×0.183 μs=3.1 ms) are for liquid crystal molecules to fully respond, nine ΔT's are for illuminating the section, and the last ΔT′ is as a buffer to prevent light leakage problem.

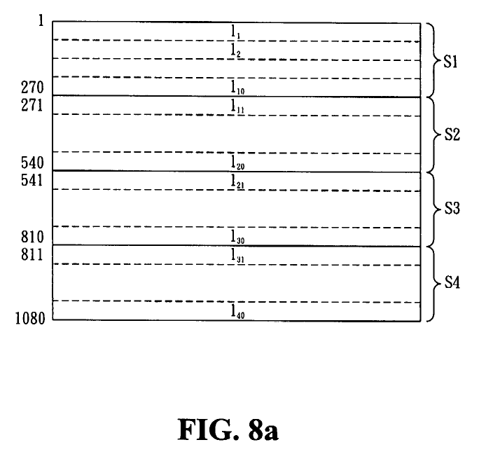

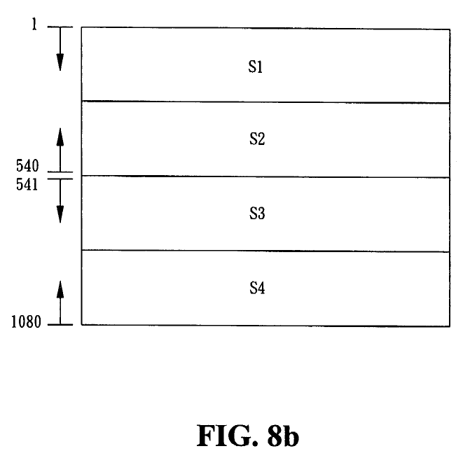

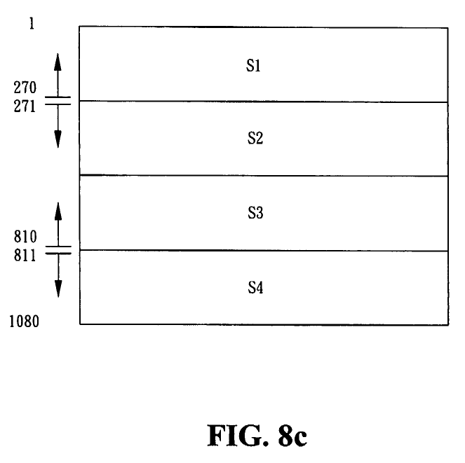

FIGS. 8a, 8b, and 8c are schematic diagrams showing the scanning sequence according to a third embodiment of the present invention. As shown in FIG. 8a, the panel is partitioned horizontally parallel to the scan lines into four scanning areas S1, S2, S3, and S4, each having 270 scan lines. The scan lines of the scanning areas S1, S2, S3, and S4 are referred to as the scan lines 1˜270, 271˜540, 541˜810, and 811˜1080, respectively. For each scanning area, its scan lines are further partitioned horizontally parallel to the scan lines into ten sections. The sections of the scanning areas S1, S2, S3, and S4 are denoted as I₁˜I₁₀, I₁₁˜I₂₀, I₂₁˜I₃₀, and I₃₁˜I₄₀, respectively. The present embodiment can have two scanning sequences as shown in FIGS. 8b and 8c respectively. In FIG. 8b, the scanning directions of the scanning areas S1 and S2 are face-to-face while the scanning directions of the scanning areas S3 and S4 are also face-to-face. In FIG. 8c, the scanning directions of the scanning areas S1 and S2 are back-to-back while the scanning directions of the scanning areas S3 and S4 are also back-to-back. The present embodiment requires 1080/4=270 gate lines and 1920×4=7680 data lines.

As the simultaneous scanning of the four scanning areas has to be finished within the 5.55-ms sub-frame time, the scanning time for each scan line is 5.55 ms/270≈20.57 μs. This speed is easily achievable by the existing technologies. Each section has 27 scan lines and the scanning time for each section is 20.57 μs×27=0.55 ms. With the 3-ms liquid crystal response time, there is about 2 ms left to turn on the LEDs. Again, the present embodiment has a ΔT=0.55 ms and each section needs 10ΔT to display a sub-frame. Within the 10ΔT, the first ΔT is for scanning image data into the section, six ΔTs (6×0.55 ms=3.3 ms) are for liquid crystal molecules to fully respond, and three ΔTs are for illuminating the section. Similarly, when the scan lines near the border between adjacent scanning areas (e.g., the scan lines 540 and 541 of FIG. 8b, and the scan lines 270, 271, and 810, 811 of FIG. 8c) are scanned according to the present invention, they contain image data of a same sub-frame and therefore there is no discontinuity phenomenon. Again, if the time unit ΔT′ is reduced to a smaller granularity, more accurate timing control can be achieved to prevent light leakage problem.

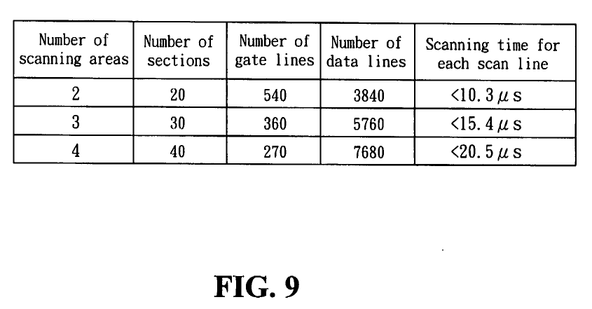

FIG. 9 is a table summarizing the features of various embodiments of the 1920×1080 LCD device according to the present invention. It can be seen from the table that, if there are more scanning areas, less gate lines but more data lines would be required. In addition, the scanning speed can be slower and therefore easier to achieve as there are more scanning areas. Please note that, even though the foregoing embodiments all have the scanning areas partitioned into ten sections, the present invention can be applied to scenarios where the scanning areas are partitioned into an appropriate number M of sections where M is any integer greater than or equal to one (when M=1, there is no partition into sections). Similarly, the present invention is not limited to the partitioning of two, three, or four scanning areas as described. The present invention can be applied to scenarios where the panel is partitioned into an appropriate number N of scanning areas where N is any integer greater than or equal to two. In contrast to the U.S. Pat. No. 6,448,951 which requires the number of sections to be a multiple of three and greater than or equal to six, the present invention allows the designer of a LCD device to strike a balance between speed and cost flexibly.

From the foregoing description, a person skilled in the related arts can easily apply the present invention's partition of scanning areas and the opposite directional scanning sequence to various LCD devices, regardless of whether they have color filter or not, whether the backlight source is based on red, green, and blue LEDs, or based on white-light LEDs, or based on cold cathode fluorescent lamps (CCFLs), or whether the frame is separated into sub-frames or not. The respective details are therefore omitted here.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A LCD device which displays a frame by presenting the frame's red, green, and blue sub-frames sequentially, comprising:
a panel having P (P≧2) scan lines, each having Q (Q≧2) pixels, said P scan lines being partitioned into non-overlapping N (N≧2) scanning areas along said scan lines, each said scanning area being further partitioned into non-overlapping M (M≧1) sections along said scan lines;
a driving mechanism having P/N gate lines, each connecting to a said scan line in each of said N scanning areas, said driving mechanism further having N×Q data lines partitioned into N groups, each having Q data lines, said Q data lines in one of said N groups being provided for writing data into said Q pixels of said scan lines in a corresponding said scanning area; and
a backlight module having N×M LED sets, each having an appropriate number of appropriately arranged red, green, and blue LEDs, said backlight module further having an appropriate driving circuit under the control of said driving mechanism to individually turn on and off said colored LEDs within each said LED set, each said LED set being positioned behind a corresponding said section of said panel;
wherein said gate lines and said scan lines are connected in a particular manner so that, when said driving mechanism enables said gate lines in a specific order to display a said sub-frame, said scan lines in any two adjacent said scanning areas are scanned line by line in opposite directions; and after a first period of time from when a said section is scanned, said corresponding LED set of said section is turned on for a second period of time.

2. The LCD device according to claim 1, wherein said scan lines in any two adjacent said scanning areas are scanned line by line towards the interfacing border of said adjacent scanning areas.

3. The LCD device according to claim 1, wherein said scan lines in any two adjacent said scanning areas are scanned line by line away from the interfacing border of said adjacent scanning areas.

4. The LCD device according to claim 1, wherein said first period of time is at least equal to the response time of liquid crystal molecules.

5. The LCD device according to claim 1, wherein said second period of time is extended until said driving mechanism begins to scan image data of a next said sub-frame into said section.

6. The LCD device according to claim 1, wherein said second period of time is extended until a third period of time before said driving mechanism begins to scan image data of a next said sub-frame into said section.

7. The LCD device according to claim 6, wherein said third period of time is at least equal to 1/L (L≧1) of the period of time required to scan a said section.

8. The LCD device according to claim 1, wherein said first and said second periods of time are multiple integrals of 1/L (L≧1) of the period of time required to scan a said section.

9. The LCD device according to claim 1, wherein said N scanning areas are arranged horizontally parallel to said scan lines.

10. The LCD device according to claim 1, wherein said N scanning areas are arranged vertically parallel to said scan lines.

11. A scanning method of a LCD device which displays a frame by presenting the frame's red, green, and blue sub-frames sequentially, said LCD device having a panel and a backlight module, said panel having P (P≧2) scan lines, each having Q (Q≧2) pixels, said backlight modules having a plurality of red, green, and blue LEDs, said scanning method comprising the steps of:
partitioning said P scan lines into non-overlapping N (N≧2) scanning areas along said scan lines, partitioning each said scanning area into non-overlapping M (M≧1) sections along said scan lines, and arranging said plurality of LEDs into N×M LED sets, each having an appropriate number of appropriately arranged red, green, and blue LEDs, wherein each said LED set being positioned behind a corresponding said section;
providing P/N gate lines, each connecting to a said scan line in each of said N scanning areas so that, when said gate lines are enabled in a specific order to display a said sub-frame, said scan lines in any two adjacent said scanning areas are scanned line by line in opposite directions, providing N×Q data lines partitioned into N groups, each having Q data lines, wherein said Q data lines in one of said N groups are for writing data into said Q pixels of said scan lines in a corresponding said scanning area; and
enabling said gate lines in said specific order to display a said sub-frame and, after a first period of time from when a said section is scanned, activating said backlight module to turn on said corresponding LED set of said section for a second period of time.

12. The scanning method according to claim 11, wherein said scan lines in any two adjacent said scanning areas are scanned line by line towards the interfacing border of said adjacent scanning areas.

13. The scanning method according to claim 11, wherein said scan lines in any two adjacent said scanning areas are scanned line by line away from the interfacing border of said adjacent scanning areas.

14. The scanning method according to claim 11, wherein said first period of time is at least equal to the response time of liquid crystal molecules.

15. The scanning method according to claim 11, wherein said second period of time is extended until said driving mechanism begins to scan image data of a next said sub-frame into said section.

16. The scanning method according to claim 1, wherein said second period of time is extended until a third period of time before said driving mechanism begins to scan image data of a next said sub-frame into said section.

17. The scanning method according to claim 16, wherein said third period of time is at least equal to 1/L (L≧1) of the period of time required to scan a said section.

18. The scanning method according to claim 11, wherein said first and said second periods of time are multiple integrals of 1/L (L≧2) of the period of time required to scan a said section.

19. The scanning method according to claim 11, wherein said N scanning areas are arranged horizontally parallel to said scan lines.

20. The scanning method according to claim 11, wherein said N scanning areas are arranged vertically parallel to said scan lines.

21. A LCD device, comprising:
a panel having P (P≧2) scan lines, each having Q (Q≧2) pixels, said P scan lines being partitioned into non-overlapping N (N≧2) scanning areas along said scan lines; and
a driving mechanism having P/N gate lines, each connecting to a said scan line in each of said N scanning areas, said driving mechanism further having N×Q data lines partitioned into N groups, each having Q data lines, said Q data lines in one of said N groups being provided for writing data into said Q pixels of said scan lines in a corresponding said scanning area;
wherein said gate lines and said scan lines are connected in a particular manner so that, when said driving mechanism enables said gate lines in a specific order to display a said sub-frame, said scan lines in any two adjacent said scanning areas are scanned line by line in opposite directions.

22. The LCD device according to claim 21, wherein said scan lines in any two adjacent said scanning areas are scanned line by line towards the interfacing border of said adjacent scanning areas.

23. The LCD device according to claim 21, wherein said scan lines in any two adjacent said scanning areas are scanned line by line away from the interfacing border of said adjacent scanning areas.

24. The LCD device according to claim 21, wherein said N scanning areas are arranged horizontally parallel to said scan lines.

25. The LCD device according to claim 21, wherein said N scanning areas are arranged vertically parallel to said scan lines.

26. A scanning method of a LCD device having a panel, said panel having P (P≧2) scan lines, each having Q (Q≧2) pixels, said scanning method comprising the steps of:
partitioning said P scan lines into non-overlapping N (N≧2) scanning areas along said scan lines;
providing P/N gate lines, each connecting to a said scan line in each of said N scanning areas so that, when said gate lines are enabled in a specific order to display a said sub-frame, said scan lines in any two adjacent said scanning areas are scanned line by line in opposite directions, providing N×Q data lines partitioned into N groups, each having Q data lines, wherein said Q data lines in one of said N groups are for writing data into said Q pixels of said scan lines in a corresponding said scanning area; and
enabling said gate lines in said specific order to display a said sub-frame.

27. The scanning method according to claim 26, wherein said scan lines in any two adjacent said scanning areas are scanned line by line towards the interfacing border of said adjacent scanning areas.

28. The scanning method according to claim 26, wherein said scan lines in any two adjacent said scanning areas are scanned line by line away from the interfacing border of said adjacent scanning areas.

29. The scanning method according to claim 26, wherein said N scanning areas are arranged horizontally parallel to said scan lines.

30. The scanning method according to claim 26, wherein said N scanning areas are arranged vertically parallel to said scan lines.
